(19) United States
(12) Patent Application Publication
(10) Pub. No.: US 2024/0375409 A1
(43) Pub. Date: Nov. 14, 2024

(54) PRINTING APPARATUS, CONTROL METHOD THEREFOR, AND STORAGE MEDIUM

(71) Applicant: CANON KABUSHIKI KAISHA, Tokyo (JP)

(72) Inventor: TOSHIHIKO IIDA, Ibaraki (JP)

(21) Appl. No.: 18/659,588

(22) Filed: May 9, 2024

(30) Foreign Application Priority Data
May 9, 2023 (JP) 2023-077009

(51) Int. Cl. B41J 2/21

(52) U.S. Cl. CPC B41J 2/2103

(57) ABSTRACT

A printhead portion for an ink color to be used during printing among a plurality of printhead portions for different ink colors, respectively, to form an image with ink is controlled to be located at a first position as a print position, and a printhead portion for an ink color not to be used during printing is controlled to be located at a second position different from the first position.

### BACKGROUND OF THE INVENTION

### Field of the Invention

The present invention relates to a printing apparatus, a control method therefor, and a storage medium.

### Description of the Related Art

In an inkjet printing system, a liquid composition (ink) containing a coloring material is ejected onto a printing medium to thereby form an image on the printing medium. To eject ink onto a printing medium, each printhead needs to be moved to a printing position near the printing medium. In such a structure, the temperature and humidity of an area in the vicinity of the printing position increase due to ejection of ink containing a lot of moisture, generation of heat by a fixing unit to dry the ink, and use of the printing medium containing moisture. Thus, it is known that dew condensation occurs on the printhead located at the printing position and the meniscus of ink is broken, which leads to issues such as deterioration in the accuracy of ejection and spilling of ink.

As a method for preventing the dew condensation, Japanese Patent Application Laid-Open Publication No. 2019-14075 discusses a method for heating a printhead to increase the temperature of the printhead to reach a temperature that is higher than the temperature of a printing medium. The dew condensation occurs when the temperature of the printhead is lower than a dew-point temperature. Even when ambient humidity is high, the dew condensation can be prevented by heating of the printhead until the temperature of the printhead reaches the same temperature as ambient temperature (e.g., 45° C.) at the printing position.

The inkjet printing system has another issue that the density of ink increases due to evaporation of moisture in the ink. If ink is continuously ejected at a certain rate or higher relative to a moisture evaporation rate, the ink density is maintained at a certain level. However, if the ink ejection rate is lower than the moisture evaporation rate, the ink density continues to increase, which leads to issues such as unevenness in printing and formation of an ink pool. As a method for preventing an increase in the density of ink, a method of maintaining the ink ejection rate by discharging ink that is not used for printing into a waste ink bottle or the like is known. However, an increase in the amount of waste ink leads directly to an increase in print cost. In particular, the above-described printhead heating method enhances the evaporation of moisture in the ink contained in the printhead, which leads to an increase in the amount of waste ink that is not used for printing.

### SUMMARY OF THE INVENTION

In view of the issues described above, the present invention is directed to reducing the amount of waste ink compared to the related art in a printing apparatus configured to heat a printhead at a print position.

To solve the above-described issues, according to an aspect of the present invention, a printing apparatus includes a plurality of printhead portions for different ink colors, respectively, the printhead portions being configured to form an image with ink, and a control unit configured to control a printhead portion for an ink color to be used during printing among the plurality of printhead portions to be located at a first position as a print position, and to control a printhead portion for an ink color not to be used during printing among the plurality of printhead portions to be located at a second position different from the first position.

Further features of the present invention will become apparent from the following description of embodiments with reference to the attached drawings.

### BRIEF DESCRIPTION OF THE DRAWINGS

FIG. 1 is a block diagram illustrating a configuration example of a print processing system according to a first embodiment.

FIG. 2 is a block diagram illustrating a hardware configuration example of an inkjet printing apparatus.

FIG. 3 is a block diagram illustrating a software configuration example of the inkjet printing apparatus.

FIG. 4 is a block diagram illustrating a hardware configuration example of a raster image processor (RIP) unit.

FIG. 5 is a block diagram illustrating a software configuration example of the RIP unit.

FIGS. 6A and 6B schematically illustrate an ink applying unit.

FIG. 7 is a flowchart illustrating a processing flow when use color information is created based on an RIP processing result.

FIGS. 8A and 8B are a flowchart illustrating a processing flow for retreat determination based on the RIP processing result.

FIGS. 9A to 9G schematically illustrate information about association between creation of use color information and each printhead position.

FIG. 10 is a flowchart illustrating a processing flow when use color information is created based on job settings.

FIG. 11 is a flowchart illustrating a processing flow for retreat determination based on job settings.

FIG. 12 illustrates an example of a user interface (UI) screen for color mode designation.

### DESCRIPTION OF THE EMBODIMENTS

### <Description of System Configuration>

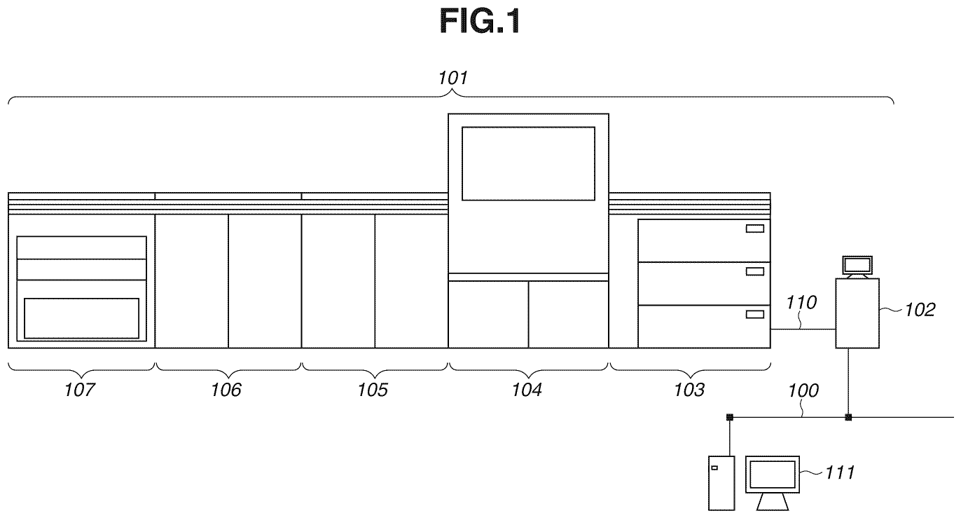

FIG. 1 is a block diagram illustrating a print processing system according to a first embodiment. In the present embodiment, an inkjet printing apparatus 101 is described as an example of an inkjet printing apparatus (printing apparatus), and an information processing apparatus 111 is described as an example of an information processing apparatus. The inkjet printing apparatus 101 and the information processing apparatus 111 are communicably connected via a network 100.

While FIG. 1 illustrates an example where the print processing system includes a single information processing apparatus 111, the inkjet printing apparatus 101 and a plurality of information processing apparatuses 111 may be communicably connected via the network 100.

The information processing apparatus 111 will now be described. The information processing apparatus 111 is configured to execute various programs such as an application program to input a job. A printer driver and a workflow application are installed on the information processing apparatus 111. A user who wishes to perform printing can issue a print instruction using various applications or the like. For example, workflow software creates a job definition format (JDF) file based on a print instruction and transmits the created JDF file and a designated print file (such as a portable document format (PDF) file) to the inkjet printing apparatus 101. In the present embodiment, a personal computer (PC) is described as an example of the information processing apparatus 111. For example, a mobile information terminal such as a smartphone or a tablet terminal may also be used as the information processing apparatus 111. A method for transmitting print data to the inkjet printing apparatus 101 can be changed as needed. Print data may be transmitted to the inkjet printing apparatus 101 via a printing application or driver, or print data may be transmitted to the inkjet printing apparatus 101 via a cloud server.

Next, the inkjet printing apparatus 101 will be described. The inkjet printing apparatus 101 has a configuration in which devices having different functions are connected to enable complicated sheet processing. Each unit constituting the inkjet printing apparatus 101 will be described below.

A raster image processor (RIP) unit 102 receives a print job from the information processing apparatus 111 via the network 100, and performs RIP processing to create density data based on print data. The RIP unit 102 includes a display and functions as a user interface for receiving an operation from the user to receive an instruction to, for example, start, stop, or cancel a print job.

A sheet feed unit 103 is a sheet feed device that is detachably attached to a printing unit 104. The sheet feed unit 103 includes at least one sheet feed deck. The printing unit 104 is configured to perform print processing on a large number of sheets using printing media contained in the sheet feed deck.

The printing unit 104 forms (prints) an image with ink on a sheet fed from the sheet feed unit 103. The configuration and operating principle of the printing unit 104 are as follows. The printing unit 104 includes an ink applying unit 203 configured to eject ink from each printhead 601 onto a printing medium to form an image, and an ink bottle containing ink to be ejected by the ink applying unit 203.

The printing unit 104 further includes a waste ink bottle for cleaning the printhead 601 and collecting discharged waste ink to maintain the density of ink at a certain level or lower, and a print belt for conveying a printing medium downstream. The ink applying unit 203 ejects ink onto a sheet to thereby form an image on the sheet. One example of the ink ejection method is a thermal system. In the thermal system, a potential is applied to a heater provided on an ink flow channel, to thereby instantaneously evaporate ink. Expansion of bubbles generated by the evaporation enables ink to be scattered. To form an image with ink on a sheet, a distance between the surface of the printhead 601 and the surface of the printing medium may be desirably set to about 1 mm. A distance 611 between the printhead 601 and the printing medium in this case is referred to as a sheet-to-sheet distance, and this position is referred to as a printing position (print position) 610.

A fixing unit 105 is a unit to perform fixing processing to dry ink ejected onto a printing medium by the printing unit 104. The fixing unit 105 includes a first fixing device for blowing heated air to dry ink, a second fixing device for causing the printing medium to pass between the second fixing device and the heated belt to thereby fix ink onto the printing medium, and a fixing belt for conveying the sheet downstream. Heated air blown by the first fixing device is high-temperature air of about 80° C., which increases the temperature of the inside of the device.

A cooling unit 106 is a unit to perform cooling processing to cool each printing medium. The printing medium that has passed through the fixing unit 105 is conveyed downstream in a state where the printing medium is heated. The cooling unit 106 includes a fan for introducing outside air, and a nozzle directed toward the printing medium, and cools the conveyed printing medium by blowing cool air to the printing medium.

A stacking unit 107 is a unit to perform processing of stacking printing media. The stacking unit 107 includes a stack tray on which printing media are stacked. The stack tray includes a stack amount detection sensor for detecting the height of stacked printing media. The stack tray is caused to ascend or descend depending on the stack amount. The stack tray also includes an eject tray which can be removed, and the eject tray is automatically discharged when the stack tray is in a full stack state.

A plurality of sheet feed units 103 and a plurality of stacking units 107 may be connected. Connecting a plurality of units enables the user to replenish printing media or take printing media out of the stacking unit 107 without interrupting printing.

### <Hardware Configuration Example of Inkjet Printing Apparatus>

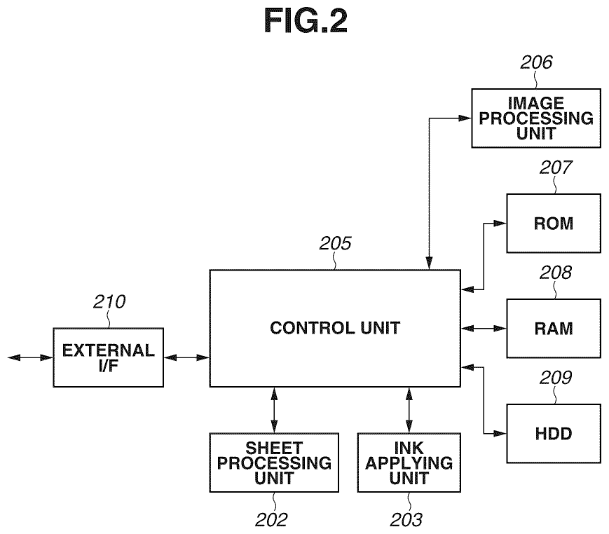

FIG. 2 is a block diagram illustrating a hardware configuration example of the inkjet printing apparatus 101. The inkjet printing apparatus 101 includes a printing function for forming an image by applying ink onto a printing medium.

The inkjet printing apparatus 101 stores RIP processed data received via an external interface (I/F) 210, which is an example of a communication unit, from the RIP unit 102 in a hard disk drive (HDD) 209, and reads out data from the HDD 209 and forms an image using the ink applying unit 203.

The ink applying unit 203 is a unit to eject ink onto a printing medium to form an image on the printing medium.

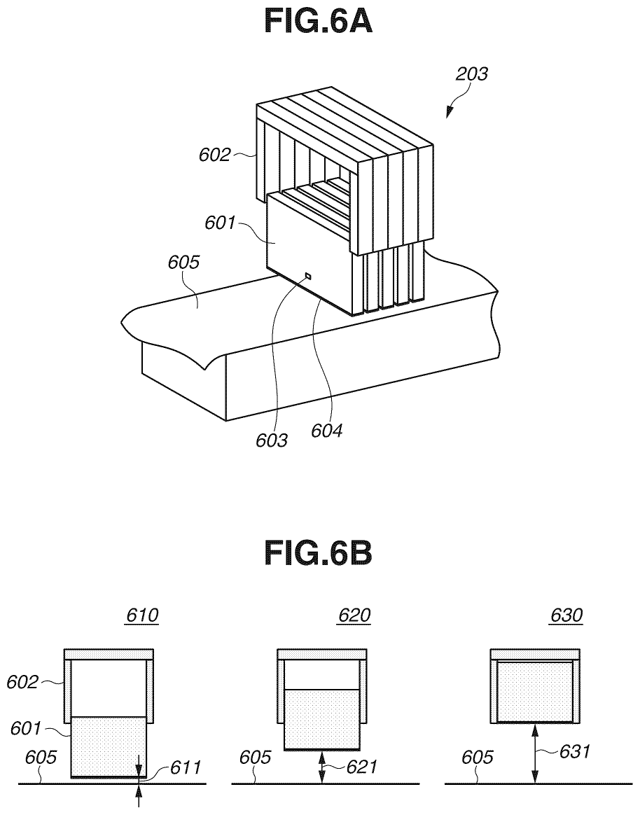

The ink applying unit 203 includes a plurality of printhead portions configured to eject ink of different respective colors, and includes a function for causing each printhead portion to retreat from a printing position (print position) or return to the printing position (print position) depending on whether to print the color on each page. The ink applying unit 203 will be described below with reference to FIGS. 6A and 6B.

A control unit 205 reads out programs stored in a read-only memory (ROM) 207 and executes the programs, to thereby cause the inkjet printing apparatus 101 to execute various operations according to the first embodiment.

The ROM 207 also stores programs and the like for the control unit 205 to interpret and process image data received from the RIP unit 102 via the external I/F 210. These programs and the like are processed by software. The ROM 207 is a read-only memory to preliminarily store various programs, including the above-described programs, boot sequence information, and font information. Various programs stored in the ROM 207 will be described in detail below. A random access memory (RAM) 208 is a readable/writable memory to store image data, various programs, setting information, and the like transmitted from the external I/F 210.

The HDD 209 stores image data processed by an image processing unit 206. The HDD 209 is configured to hold a plurality of pieces of data such as print data on processing target jobs. The control unit 205 stores the RIP processed data input via the external I/F 210 in the HDD 209, reads out data from the HDD 209, and outputs the data to the ink applying unit 203 to perform printing based on the data. Further, the control unit 205 controls job data read out from the HDD 209 to be transmitted to an external apparatus via the external I/F 210. Thus, the control unit 205 executes various kinds of output processing on the data on processing target jobs stored in the HDD 209. The image processing unit 206 performs image processing, such as screening, on the RIP processed data stored in the RAM 208 or the HDD 209. The control unit 205 also controls the operation of a sheet processing unit 202. The sheet processing unit 202 corresponds to the sheet feed unit 103 and the stacking unit 107, which are described above with reference to FIG. 1, and a sheet conveyance belt 605 that extends from the sheet feed unit 103 to the stacking unit 107.

The external I/F 210 transmits and receives image data, print settings, a job state, and the like to and from the RIP unit 102. The HDD 209 also stores various kinds of management information and the like to be permanently stored, changed, or managed by the inkjet printing apparatus 101. The ROM 207 stores programs for executing various kinds of processing and the like in flowcharts to be executed by the control unit 205 as described below. The ROM 207 stores various control programs to be used in the first embodiment.

### <Software Configuration Example of Inkjet Printing Apparatus>

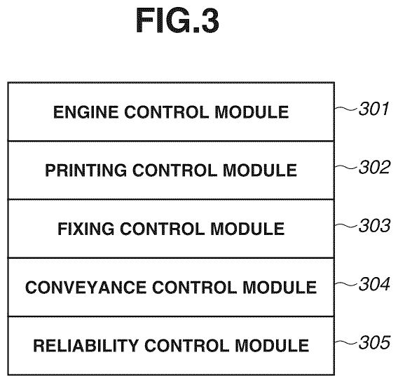

FIG. 3 is a block diagram illustrating a software configuration example of the inkjet printing apparatus 101. The control unit 205 of the inkjet printing apparatus 101 uses control modules to control each unit of the inkjet printing apparatus 101.

An engine control module 301 controls the overall operation of the inkjet printing apparatus 101.

A printing control module 302 controls the ink applying unit 203 to perform printing on a printing medium. The engine control module 301 delivers the RIP processed data received from the RIP unit 102 to the printing control module 302, and issues a printing instruction to the printing control module 302. The printing control module 302 determines ink not to be used for printing based on the RIP processed data, and determines whether the printhead 601 can retreat. If it is determined that the printhead 601 can retreat, the printhead 601 is moved to a retreat position 620. If it is determined that the printhead 601 needs to move to the printing position 610, the printhead 601 is moved to the printing position 610. The printhead 601 is moved to a standby position 630 during power-off of the inkjet printing apparatus 101 or during idling or maintenance when no print job is received. The printing control module 302 also controls a temperature control heater 604 to operate or stop operating depending on the position of the printhead 601. Specifically, the printing control module 302 controls the printhead 601 to be heated to reach a given temperature at the printing position 610, and stops heating at the retreat position 620 and the standby position 630. During printing, the printing control module 302 controls ejection of ink from each printhead 601.

A fixing control module 303 controls the fixing unit 105 and the cooling unit 106.

A temperature sensor installed in each unit controls the temperature of the heater and controls door locking and unlocking.

A conveyance control module 304 controls the sheet processing unit 202 to convey a printing medium. The conveyance control module 304 adjusts an appropriate conveyance speed and an interval between media depending on the type and size of each printing medium, and controls printing to be performed at a predetermined speed.

A reliability control module 305 performs processing of detecting deformation of a printing medium, contamination of foreign material, or the like and resolving such issues. If an abnormality is detected by various sensors, the printing operation is stopped.

### <Hardware Configuration Example of RIP Unit>

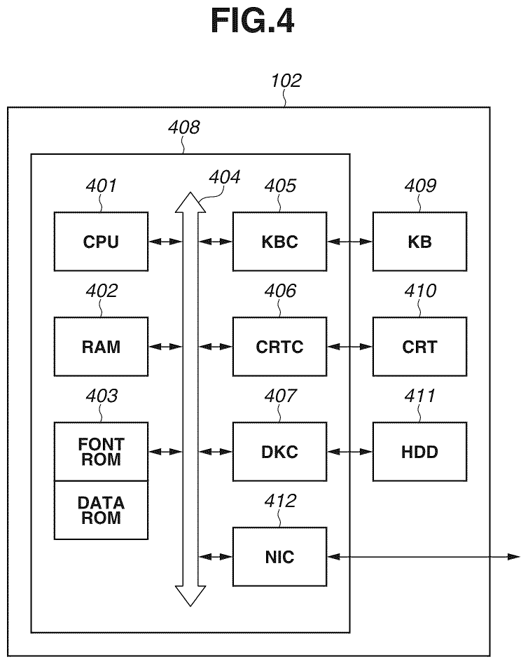

FIG. 4 is a block diagram illustrating a hardware configuration example of the RIP unit 102.

A central processing unit (CPU) 401 executes programs such as an operating system (OS) and general applications that are stored in a program ROM in a ROM 403 or are loaded into a RAM 402 from a HDD 411. The ROM 403 includes a font ROM and a data ROM. The RAM 402 functions as a main memory, a work area, and the like for the CPU 401. A keyboard controller (KBC) 405 controls input from a keyboard (KB) 409 or a pointing device (not illustrated). A display controller (CRTC) 406 controls display on a display unit (CRT) 410. A disk controller (DKC) 407 controls access to the HDD 411 or the like that stores a boot program, various applications, font data, and the like.

A network controller (NIC) 412 is connected to a network and executes communication control processing with other devices connected to the network. A bus 404 connects the CPU 401, the RAM 402, the ROM 403, various controllers, and the like to transmit data signals and control signals.

In a case of a mobile terminal, a touch panel controller or the like may be included in the configuration in place of the KBC 405. Further, a large-capacity storage device may be included in place of the HDD 411. The internal configuration of the NIC 412 varies depending on whether the system includes a wired local area network (LAN), a wireless LAN, or both the wired LAN and the wireless LAN. However, differences originating from these internal configurations are hidden in the NIC 412 and the NIC 412 is configured to control the system as an equivalent NIC to the other modules illustrated in FIG. 4. A plurality of NICs 412 may be used.

### <Software Configuration Example of RIP Unit>

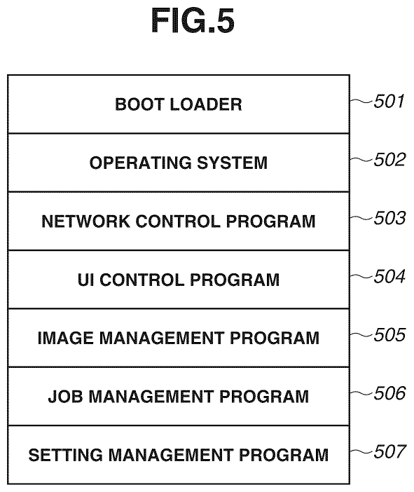

FIG. 5 is a block diagram illustrating a software configuration example of the RIP unit 102.

A boot loader 501 is a program to be executed immediately after power-on of the RIP unit 102. This program includes a program for executing various activation sequences for activating the system.

An operating system 502 is a program for providing an environment for executing various programs to implement the functions of the RIP unit 102. The operating system 502 provides functions such as management of resources, including memories of the RIP unit 102, i.e., the ROM 403, the RAM 402, and the HDD 411.

A network control program 503 is a program to be executed when data is transmitted to and received from devices connected via a network. Specifically, the network control program 503 is software for controlling the NIC 412 to transmit and receive data and files to and from the inkjet printing apparatus 101 and the information processing apparatus 111 via the network 100. The network control program 503 receives a data transmission instruction from another program, adds an appropriate header to data, and transmits the data to a destination.

A user interface (UI) control program 504 detects a user operation on the KB 409 or the CRT 410, and displays various kinds of information on the CRT 410.

An image management program 505 generates image data by performing RIP processing on page description language (PDL) data obtained from a job management program 506 based on print settings managed by a setting management program 507. The image management program 505 outputs the RIP processed image data to the job management program 506.

The job management program 506 outputs PDL data obtained from the information processing apparatus 111 to the image management program 505. The job management program 506 transmits print settings associated with print data obtained from the image management program 505 to the inkjet printing apparatus 101. In the present embodiment, the RIP processed image data is sequentially transmitted page by page to the inkjet printing apparatus 101 immediately after completion of RIP processing. In the present embodiment, in the case of printing a plurality of copies, the inkjet printing apparatus 101 uses image data stored in the HDD 209 without retransmitting RIP processed image data, but instead image data may be retransmitted from the RIP unit 102. Further, the job management program 506 monitors the execution state of a print job for printing based on transmitted print data.

The setting management program 507 manages settings for jobs to be made via the KB 409 or the CRT 410.

### <Ink Applying Unit>

FIGS. 6A and 6B schematically illustrate the ink applying unit 203 in the printing unit 104 of the inkjet printing apparatus 101 according to the present embodiment. The ink applying unit 203 includes the full-line printheads 601 extending in a depth direction of the inkjet printing apparatus 101, and nozzles are located on a lower surface of each printhead 601 such that the nozzles cover a maximum width of a printing medium. This configuration enables high-speed printing without moving the nozzles in the depth direction.

FIGS. 6A and 6B illustrate an example where five printheads 601 are provided. The printheads 601 eject various types of ink, respectively, but instead a plurality of printheads 601 may eject the same type of ink. Spot color ink, as well as yellow ink, magenta ink, cyan ink, and black ink can be used depending on a print product. Each printhead 601 is provided with a temperature control heater and a temperature/humidity sensor 603, and is configured to read the current temperature and humidity of the printhead 601.

Each printhead 601 is sandwiched between rails 602 and includes a driving mechanism capable of driving each printhead 601 in a height direction along the rails. Each printhead 601 controls the driving mechanism to move (locate) to the standby position 630 during power-off of the inkjet printing apparatus 101, when processing associated with printing is not performed, or during maintenance. The conveyance belt 605 conveys a printing medium and each printhead 601 is moved (located) to the printing position (print position) 610, which corresponds to a height of about 1 mm from the printing medium, to perform printing. The temperature at the printing position 610 increases due to heat generated by the apparatus, and the humidity at the printing position 610 also increases because ink is ejected in this area. To prevent dew condensation on each printhead 601, it may be desirable to heat each printhead 601 by the temperature control heater 604 described above in the case of moving each printhead 601 to the printing position 610.

In the present embodiment, not only the above-described two positions, i.e., the printing position 610 and the standby position 630, but also the retreat position 620 is defined. The retreat position 620 is a position where the printhead 601 for a color that is not to be used during printing is caused to retreat. The retreat position 620 is defined as a position where dew condensation does not occur on the printhead 601 even when the printhead 601 is not heated. Each of these positions will be described below.

The printheads 601 can be independently controlled. Specifically, only a driving system for a specific printhead 601 may be controlled to move the specific printhead 601 to the printing position and operate the temperature control heater 604, while another printhead 601 may not be moved from the retreat position 620.

FIG. 6B schematically illustrates a state of the printhead 601 as viewed along a sheet conveyance direction. At the printing position 610, the distance 611 between the printing medium on the conveyance belt 605 and the leading edge of the printhead 601 is only about 1 mm. Because the humidity and temperature at the printing position 610 are high, dew condensation occurs on a nozzle portion of the printhead 601. The temperature control heater 604 heats the printhead 601 to reach the same temperature as ambient temperature, thereby preventing dew condensation on the printhead 601 even at the printing position 610 where humidity is high.

The standby position 630 is a position where the printhead 601 is accommodated during idling or maintenance when printing is not performed, and the printhead 601 is fully accommodated in a frame so as to prevent the printhead 601 from being damaged due to contact or vibration caused during maintenance. In this case, a distance 631 between the conveyance belt 605 and the leading edge of the printhead 601 is, for example, 30 cm.

The retreat position 620 indicates a position where the printhead 601 for a color not to be used in the present embodiment is caused to retreat. The printhead 601 is moved to the retreat position 620 so that evaporation of moisture from ink can be suppressed by stopping heating of the printhead 601 to prevent dew condensation. Accordingly, the distance between the conveyance belt 605 and the leading edge of the printhead 601 is a distance at which dew condensation does not occur even when the printhead 601 is not heated by the temperature control heater 604. On the other hand, the printhead 601 located at the retreat position 620 needs to be returned to the printing position 610 when the printhead 601 is used for subsequent printing. Accordingly, it may be desirable to minimize the distance between the retreat position 620 and the printing position 610 and to minimize the movement time. Therefore, the retreat position 620 is set at a position that is as close as possible to the printing position 610 without causing dew condensation.

To strictly define the retreat position 620 as a position closest to the printing position 610, it may be desirable to measure a change in the distance from the printing position 610, temperature, and humidity by a dew point thermometer in an installation environment. However, effects due to the installation environment are smaller than effects of heat and humidity generated by the inkjet printing apparatus 101, and thus the retreat position 620 may be set as a constant value for the inkjet printing apparatus 101. In this case, for example, the retreat position 620 may be determined under conditions in which the retreat position 620 is farthest from the printing position 610, or under worst conditions, among the installation conditions allowed for the inkjet printing apparatus 101.

For example, assuming that the movement speed of the printhead 601 is 3 cm per second and a distance 621 between the conveyance belt 605 and the leading edge of the printhead 601 at the retreat position 620 is 18 cm, and it takes six seconds to move the printhead 601 to the retreat position 620. It takes the same time for the printhead 601 to return to the printing position 610. Accordingly, the printhead 601 can be caused to retreat if the printhead 601 is not used for 12 seconds or longer. If the printing speed of the inkjet printing apparatus 101 is 150 ppm, 30 pages can be printed for 12 seconds, and thus the number of sheets to be printed for retreat corresponds to 30 pages. Further, since it takes time for one way to return the printhead 601 at the retreat position 620 to the printing position 610, the number of sheets to be printed for return corresponds to 15 pages which is half of the number of sheets to be printed for retreat.

If the distance 621 between the conveyance belt 605 and the leading edge of the printhead 601 at the retreat position 620 is 15 cm, the printhead 601 can be caused to retreat in 10 seconds and the number of sheets to be printed for retreat corresponds to 25 pages.

Thus, setting the retreat position 620 as close as possible to the printing position 610 makes it possible to increase time for allowing the printhead 601 to retreat and to prevent evaporation of moisture in ink.

In the present embodiment, a method for identifying ink to be used for printing each pixel based on color data obtained by RIP processing to determine the printhead 601 for an ink color not to be used for printing all pixels to be the printhead 601 that can be caused to retreat, and causing the printhead 601 to retreat will be described.

Use color information 901 according to the present embodiment indicates an ink color to be used for each page determined based on color data obtained by RIP processing.

### <Processing of Control Unit Upon Receiving RIP Processed Data>

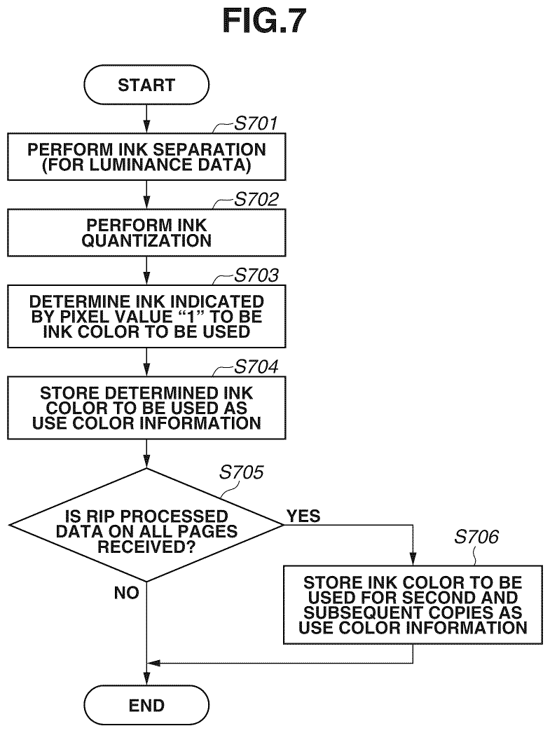

FIG. 7 is a flowchart illustrating a processing flow when the printing unit 104 receives RIP processed image data from the RIP unit 102.

In step S701, the control unit 205 determines whether color data in the received RIP processed data is red, green, and blue (RGB) luminance data. If the received color data is luminance data, an RGB color space is associated with a color space represented by a CMYK color space of the inkjet printing apparatus 101 and a spot color, and the luminance data is converted into density data corresponding to an ink color. If the color data is density data corresponding to the ink color, this processing is skipped. The RIP unit 102 generally treats only one of these types of data. If ink separation is to be performed or if this processing is skipped, the processing proceeds to step S702.

In step S702, the control unit 205 quantizes 8-bit density data, which is received or created by ink separation, into 1-bit data. The 1-bit data has a pixel value “1” to indicate that printing with the ink is performed, and a pixel value “O” to indicate that printing with the ink is not performed. The printing control module 302 drives the ink applying unit 203 based on the binary data to form an image.

After the ink quantization, the processing proceeds to step S703.

In step S703, the control unit 205 determines ink indicated by the pixel value “1” within the page to be a color to be used for the page. After the determination, the processing proceeds to step S704.

In step S704, the control unit 205 stores the ink color determined to be used in step S703 in association with the page as the use color information 901. After the use color information 901 is stored, the processing proceeds to step S705.

In step S705, the control unit 205 determines whether the received RIP processed data is RIP processed data on the last page for the job. Assume herein that the RIP unit 102 issues a notification after transmission of the RIP processed data on the last page, and it is determined that the RIP processed data on the last page is received upon reception of the notification. If the RIP processed data on the last page is received (YES in step S705), the processing proceeds to step S706. If the RIP processed data on the last page is not received (NO in step S705), this processing flow ends.

In step S706, the control unit 205 repeatedly stores the ink color to be used for each page determined in step S703 as the use color information 901 by a number of times obtained by subtracting “1” from the number of copies. In the case where five copies of 100 pages are printed, the colors to be used for 100 pages determined in step S703 are repeatedly stored four times. After the storage, this processing flow ends.

### <Processing of Control Unit Upon Start of Printing of Each Page>

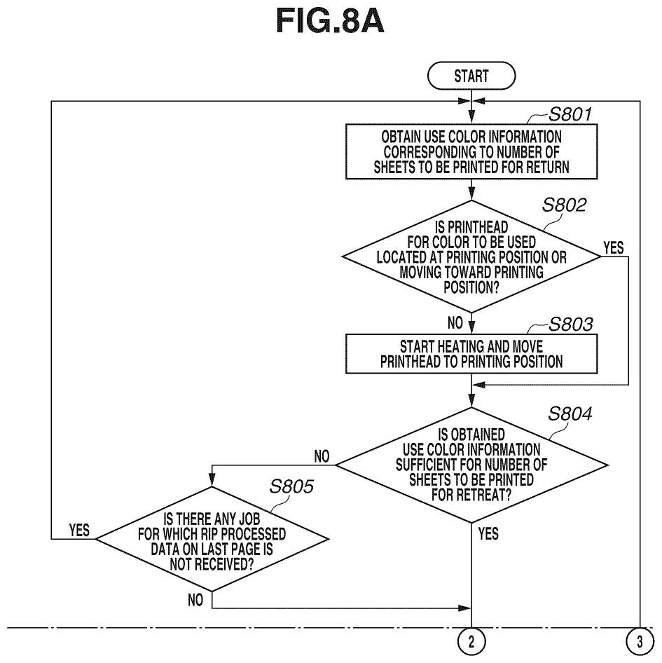

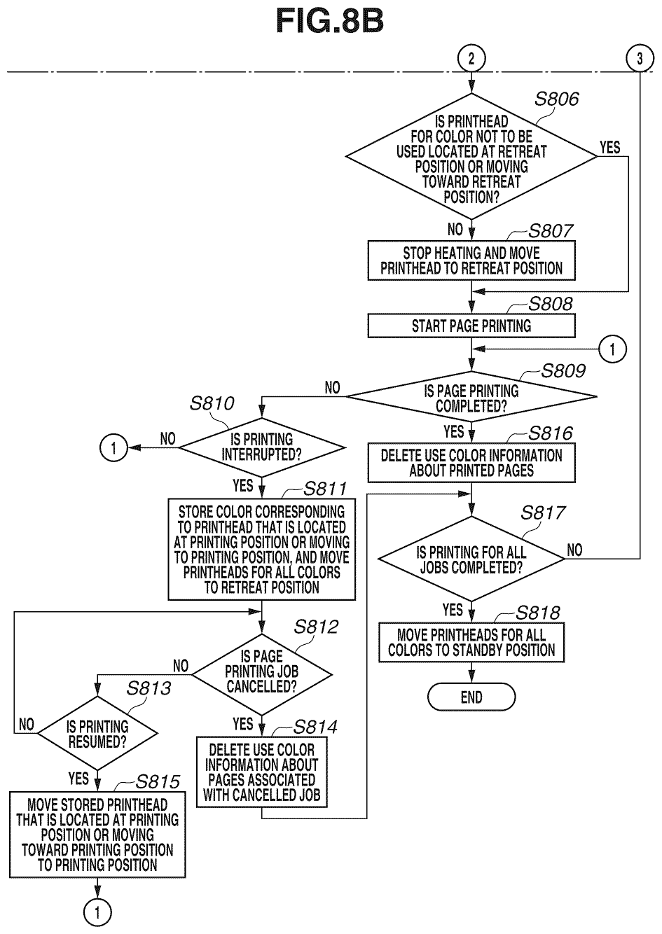

FIGS. 8A and 8B are a flowchart illustrating a processing flow when the control unit 205 forms an image for each page on a printing medium after ink quantization. The printhead 601 not to be used for printing is moved to the retreat position 620 and the printhead 601 to be used for printing is moved to the printing position 610 based on the use color information 901.

In step S801, the control unit 205 obtains use color information 901 corresponding to the number of sheets to be printed for return.

As described above, the number of sheets to be printed for return is the number of sheets that can be printed during a period for the printhead 601 to move from the retreat position 620 to the printing position 610. If the stored use color information 901 is less than the number of sheets to be printed for return, all pieces of stored use color information 901 are obtained. The present embodiment can also be applied to an inkjet printing apparatus that uses roll paper. In the case where roll paper is used, a length of paper that can be printed during a period for a reciprocating movement is identified in the same manner and the use color information 901 corresponding to the number of pages that can be printed on the paper with the length is obtained. After the use color information 901 is obtained, the processing proceeds to step S802.

In step S802, the control unit 205 determines a color to be used for at least one page by referring to the use color information 901 obtained in step S801. It is determined whether the printhead 601 for the color is located at the printing position 610 or is moving toward the printing position 610. If there is no color to be used, or if all the printheads 601 for colors to be used are located at the printing position 610 or are moving toward the printing position 610 (YES in step S802), the processing proceeds to step S804. In the other cases (NO in step S802), the processing proceeds to step S803.

In step S803, the control unit 205 issues an instruction to move the printhead 601, determined in step S802 to be the printhead 601 for the color to be used and not to be located at the printing position 610 or not to move toward the printing position 610, to the printing position 610. In this case, to prevent dew condensation on the printhead 601, heading (temperature control) of the printhead 601 is started. After the movement instruction is issued, the processing proceeds to step S804.

In step S804, the control unit 205 obtains the use color information 901 corresponding to the number of sheets for retreat determination.

As described above, the number of sheets to be printed for return indicates the number of sheets that can be printed during a period for a reciprocating movement of the printhead 601 between the retreat position 620 and the printing position 610. The number of sheets for retreat determination is about twice as much as the number of sheets to be printed for return. After obtaining, the processing proceeds to step S804.

In step S804, the control unit 205 determines whether the obtained use color information 901 is sufficient for the number of sheets to be printed for retreat. If the obtained use color information 901 is sufficient (YES in step S804), the processing proceeds to step S806. If the obtained use color information 901 is not sufficient (NO in step S804), the processing proceeds to step S805.

In step S805, the control unit 205 determines whether there is any job for which RIP processed data on the last page is not received among the jobs for which the print instruction is received. If there is a job for which RIP processed data on the last page is not received (YES in step S805), the processing returns to step S801 to wait until the use color information 901 is more than or equal to the number of sheets to be printed for retreat or until the RIP processed data on the last page is received. If there is no job for which RIP processed data on the last page is not received (NO in step S805), the processing proceeds to step S806.

In step S806, the control unit 205 determines whether there is a color not to be used for printing by referring to the use color information 901 obtained in step S801. The control unit 205 further determines whether the printhead 601 for the color is located at the retreat position 620 or is moving toward the retreat position 620. The position of the printhead 601 can be obtained from the printing control module 302. If there is no color not to be used, or if all the printheads 601 for colors not to be used are located at the retreat position 620 or are moving toward the retreat position 620 (YES in step S806), the processing proceeds to step S808. In the other cases (NO in step S806), the processing proceeds to step S807.

In step S807, the control unit 205 issues an instruction to move the printhead 601, determined in step S806 to be the printhead 601 for the color not to be used and not to be located at the retreat position 620 or not to move toward the retreat position 620, to the retreat position 620. In this case, heating of the printhead 601 is stopped. After the movement instruction is issued, the processing proceeds to step S808.

In step S808, the control unit 205 starts page printing. This processing is similar to normal page printing. After page printing, the processing proceeds to step S809.

In step S809, the control unit 205 determines whether page printing is completed. If page printing is completed (YES in step S809), the processing proceeds to step S816. If page printing is not completed (NO in step S809), the processing proceeds to step S810.

In step S810, the control unit 205 determines whether printing is interrupted. Printing may be interrupted not only when an interrupt instruction is issued by an operator, but also when an error such as a paper jam occurs. If printing is interrupted (YES in step S810), the processing proceeds to step S811. If printing is not interrupted (NO in step S810), the processing returns to step S809 to wait until page printing is completed or the job is interrupted.

In step S811, the control unit 205 stores the color for the printhead 601 that is located at the printing position 610 or is moving toward the printing position 610, and issues an instruction to move the printheads 601 for all colors to the retreat position 620. After the movement instruction is issued, the processing proceeds to step S812.

In step S812, the control unit 205 determines whether the job for page printing is cancelled. The job can be cancelled by the printing control module 302 based on a user operation or a determination that printing cannot be performed. If the job is cancelled (YES in step S812), the processing proceeds to step S814. If the job is not cancelled (NO in step S812), the processing proceeds to step S813.

In step S813, the control unit 205 determines whether printing in the interrupted job is resumed. If printing is resumed (YES in step S813), the processing proceeds to step S815. If printing is not resumed (NO in step S813), the processing returns to step S812 to wait until the job is resumed or cancelled.

In step S814, the control unit 205 deletes the use color information 901 associated with pages for the cancelled job. After the deletion, the processing proceeds to step S817.

In step S815, the control unit 205 moves the printhead 601 stored in step S811, which is located at the printing position 610 or is moving toward the printing position 610, to the printing position 610. After the movement, the processing returns to step S809.

In step S816, the control unit 205 deletes the use color information 901 on the printed pages. After the deletion, the processing proceeds to step S817.

In step S817, the control unit 205 determines whether printing of all pages is completed.

If printing of all pages is completed (YES in step S817), the processing proceeds to step S818. If printing of all pages is not completed (NO in step S817), the processing returns to step S801 to perform printing processing (print processing) on the next page.

In step S818, the control unit 205 issues an instruction to move all the printheads 601 to the standby position 630. After the instruction is issued, this processing flow ends.

### <Examples of Printhead Retreat Timings>

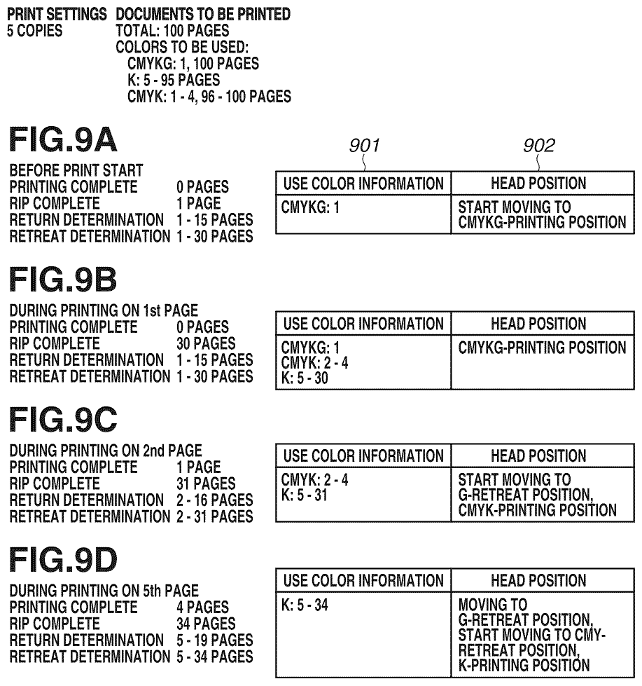

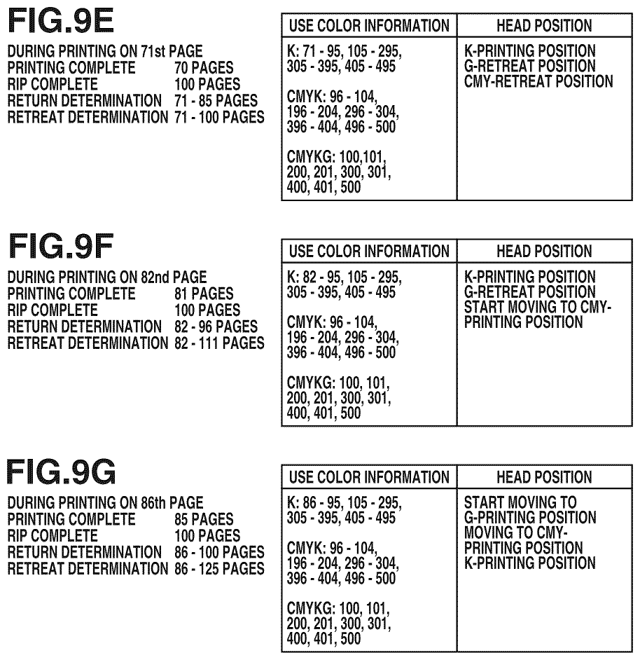

FIGS. 9A to 9G schematically illustrate the use color information 901 and a printhead position 902 that are stored in the printing control module 302 in page print processing. A movement of each printhead 601 will be described with reference to FIGS. 9A to 9G. In the following description, cyan, magenta, yellow, and black are represented by C, M, Y, and K, respectively, and a spot color is represented by gold (G). Printing processing according to the present embodiment refers to general print processing.

To simplify the description, assume that an RIP processing speed is equal to a printing speed, the number of sheets to be printed for retreat is 30 sheets, and the number of sheets to be printed for return is 15 sheets. Also, assume that only printing of five copies is designated in job settings.

FIG. 9A illustrates the use color information 901 and the printhead position 902 when printing processing is first performed to print RIP processed data on the first page.

Only the colors to be used for the first page are stored as the use color information 901. In step S801, the use color information 901 on the first page is obtained. All CMYKG ink colors are used for the first page, and thus the printheads 601 for CMYKG colors, respectively, start to move to the printing position 610. The use color information 901 is less than the number of sheets to be printed for retreat. Accordingly, the processing returns to step S801 through steps S804 and S805.

FIG. 9B illustrates the use color information 901 and the printhead position 902 when RIP processing on the first 30 pages is completed. All the printheads 601 are located at the printing position 610. The use color information 901 corresponding to the number of sheets to be printed for retreat is obtained, and thus the processing proceeds to step S806 from step S804. After printing, the processing returns to step S801 from step S817.

FIG. 9C illustrates the use color information 901 and the printhead position 902 when printing processing is performed on the second page. The retreat determination is performed based on the use color information 901 on the second page to 31st page. The G color is not used for any page, and thus the processing proceeds to step S807 from step S806. The printhead 601 for G is moved to the retreat position 620.

FIG. 9D illustrates the use color information 901 and the printhead position 902 when printing processing is performed on the fifth page. The retreat determination is performed based on the use color information 901 about the fifth page to 34th page. CMYG colors are not used for any page, and thus the processing proceeds to step S807 from step S806. The printheads 601 for CMY colors, respectively, are moved to the retreat position 620. The printhead 601 for G has already started to move. Accordingly, the printhead 601 for G is not moved in this case.

FIG. 9E illustrates the use color information 901 and the printhead position 902 during printing of the 71st page. Since the RIP processing on all pages is completed, the colors to be used for the pages corresponding to the number of copies to be printed is added as the use color information 901 in step S706. Five copies of documents of 100 pages on which the RIP processing is completed are printed. Accordingly, the colors to be used for the first page to 500th page are determined. Only the color to be used for the 71st page to 85th page is used for return determination, and thus only K is used. Accordingly, the processing proceeds to step S804 from step S802 without moving the printhead 601 to the printing position 610.

FIG. 9F illustrates the use color information 901 and the printhead position 902 during printing of the 82nd page. The return determination is performed based on the colors to be used for the 82nd page to 96th page. Since CMYK colors are used for the 96th page. Accordingly, the processing proceeds to step S803 from step S802 to start movement of the printheads 601 for CMY colors, respectively, to the printing position 610. The printhead 601 for K is already located at the printing position 610, and thus the printhead 601 for K is not moved in this case.

FIG. 9G illustrates the use color information 901 and the printhead position 902 during printing of the 86th page. The return determination is performed based on the colors to be used for the 86th page to 100th page. Since CMYKG colors are used for the 100th page, the processing proceeds to step S803 from step S802 to start movement of the printhead 601 for G to the printing position 610. The printhead 601 for K is already located at the printing position 610 and the printheads 601 for CMY colors, respectively, are already moving toward the printing position 610, and thus these printheads 601 are not moved in this case.

As described above, the return determination is performed based on 15 pages and the retreat determination is performed based on 30 pages. The printheads 601 are moved based on the determinations. Since the printheads 601 for colors to be used during printing are located at the printing position 610, there is no need to interrupt printing, and the printheads 601 can be located at the retreat position 620 when the printheads 601 are not used during printing, which eliminates the need for heating the printheads 601. Consequently, evaporation of moisture in ink can be suppressed.

The retreat position 620 may be desirably set at a position which is as close as possible to the printing position 610 and at which dew condensation does not occur even when the printheads 601 are not heated. In the example described above, if the difference between the retreat position 620 and the printing position 610 is 15 cm and the movement time is five seconds, the number of sheets to be printed for retreat is 25 sheets and the number of sheets to be printed for return is 13 sheets. Thus, each printhead 601 can be moved to the retreat position 620 with less sheets, and the movement of the printhead 601 to the printing position 610 can be delayed.

In the present embodiment, not only the printing position 610 and the standby position 630, but also the retreat position 620 is defined, and an example where the printhead 601 for a color not to be used for printing is caused to retreat to the retreat position 620 is described. However, the printhead 601 for a color not to be used for printing may be moved to the standby position 630, instead of moving the printhead 601 to the retreat position 620, as long as the printhead 601 for a color not to be used for printing is located at a position where heating is not required (position where dew condensation does not occur even when the printhead 601 is not heated).

According to the present embodiment, the printhead 601 for a color not to be used for printing is caused to retreat to a position where heating is not required, thereby eliminating the need to heat the printhead 601 located at the retreat position 620. Consequently, it is possible to suppress evaporation of moisture in ink and to reduce the amount of waste ink.

In the first embodiment, a method for determining ink to be used for each page based on a RIP processing result and causing the printhead 601 for a color not to be used for printing to retreat to thereby suppress evaporation of moisture in ink contained in the printhead 601 is described. In this method, the printhead 601 for each color can be caused to retreat. However, it is difficult to determine whether the printhead 601 for each color can be caused to retreat until RIP processing corresponding to the number of sheets for retreat determination is completed. A second embodiment illustrates an example where a color to be used for each page is determined based on job print settings and it can be determined whether the printhead 601 for a color to be used for printing can be caused to retreat before RIP processing is completed.

The use color information 901 according to the present embodiment indicates an ink color to be used for each page determined based on color mode designation. A color mode can be designated such that the user who wishes to perform printing for the entire job or for each page selects “color”, “monochrome”, or “spot color” via the KB 409 or the CRT 410 of the RIP unit 102.

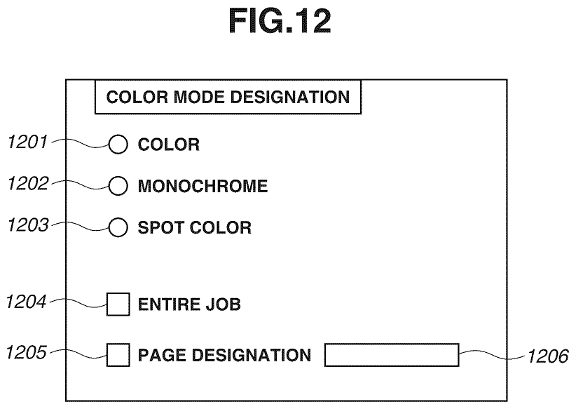

FIG. 12 illustrates an example of a screen for color mode designation. On the screen for color mode designation, color 1201, monochrome 1202, and spot color 1203 can be designated. The spot color 1203 can be further designated after the color 1201 or the monochrome 1202 is designated.

The designated color mode for entire job 1204 or page designation 1205 can be selected. If the page designation 1205 is selected, the user inputs a page number to page number 1206.

### <Processing of Control Unit Upon Reception of Print Settings>

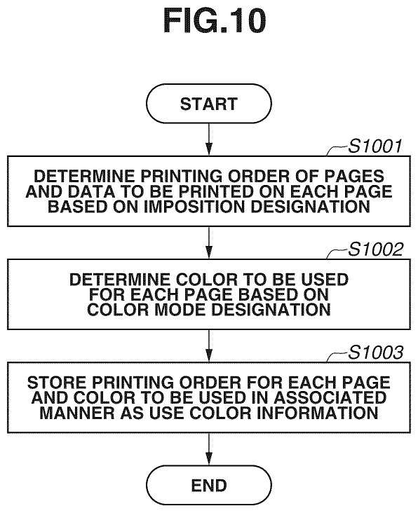

FIG. 10 is a flowchart illustrating a processing flow when the printing unit 104 receives print settings including the color mode from the RIP unit 102.

In step S1001, the control unit 205 determines data to be printed on each page and a printing order of pages based on imposition designation in the print settings. For example, if 2-in-1 printing or printing of two pages on one sheet is designated, data to be printed on the first page includes first and second pages of print data. The printing order of all pages can be determined based on print settings. After the data and the printing order are determined, the processing proceeds to step S1002.

In step S1002, the control unit 205 determines a color to be used for each page based on color mode designation in print settings. If color printing is determined, cyan ink, magenta ink, yellow ink, and black ink are determined to be ink colors to be used. If monochrome printing is determined, black ink is determined to be an ink color to be used. In the present embodiment, the color mode can be designated for each page. In the example described above, if color printing is designated for the first page of print data and monochrome printing is designated for the second page of print data, color printing is performed on the first half of the first page and monochrome printing is performed on the latter half of the first page, and thus cyan, magenta, yellow, and black are used as ink colors. To more efficiently cause the printheads 601 to retreat, it may be desirable to designate whether to perform printing using a spot color in the color mode. If color printing with no spot color is designated, the spot color can be determined to be a color not to be used. After the colors to be used for each page are determined, the processing proceeds to step S1003.

In step S1003, the control unit 205 stores the colors to be used for all pages as the use color information 901. After the use color information 901 is stored, this processing flow ends.

If the color mode cannot be designated for each page and is designated for each job, in step S1002, colors to be used for the job (all pages included in the job) are determined based on the designated color mode.

In step S1002, for example, if it cannot be determined whether printing is performed using a certain color (e.g., spot color), the certain color is determined to be a color to be used. This determination makes it possible to prevent the printhead 601 for ink that can be used for printing from being located at a position other than the printing position at a printing timing.

### <Processing of Control Unit Upon Start of Printing of Each Page>

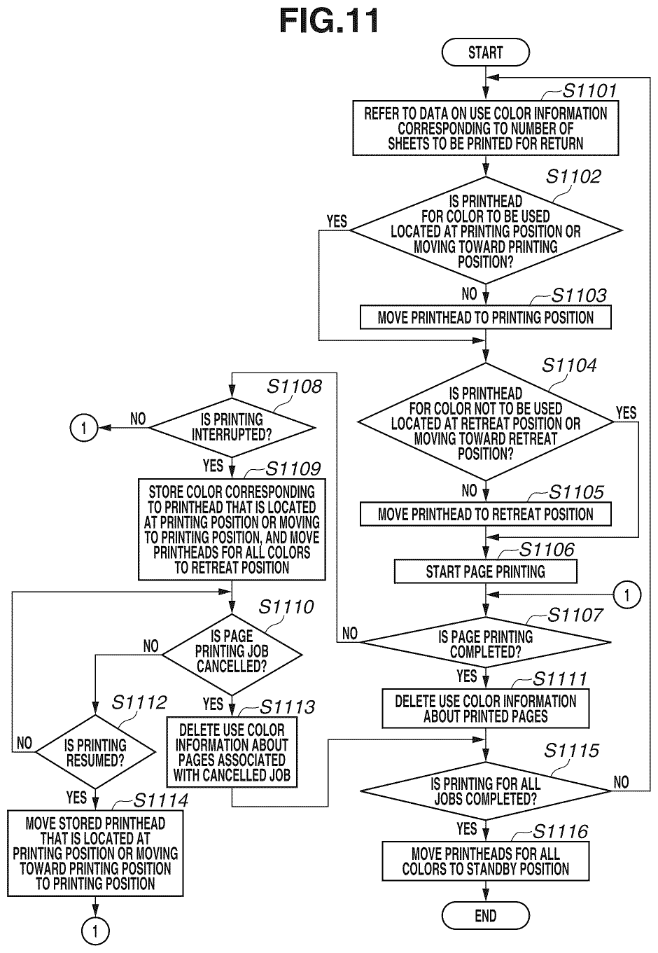

FIG. 11 is a flowchart illustrating a processing flow when the control unit 205 forms an image for each page on a printing medium. The printhead 601 not to be used for printing is caused to retreat and the printhead 601 to be used for printing is moved to the printing position based on the use color information 901.

Almost all processes in FIG. 11 are similar to those in FIGS. 8A and 8B according to the first embodiment. In the first embodiment, a color to be used for printing is determined not based on print settings, but based on the RIP processing result. Accordingly, there is a need to wait in step S804 until the use color information 901 corresponding to the number of sheets for retreat determination can be obtained, and thus printing cannot be started before RIP processing corresponding to the number of sheets for retreat determination is completed. On the other hand, in the second embodiment, information to be used for determination can be obtained upon reception of data on each page. Accordingly, there is no need to store the use color information 901 and printing of pages on which RIP processing is completed can be sequentially performed.

In the inkjet printing apparatus 101 and an inkjet printing method according to the present embodiment, a color not to be used for printing is determined based on print settings, thereby making it possible to cause the printheads 601 to properly retreat without decreasing the print speed.

### Other Embodiments

The present invention can also be implemented by the following processing. That is, a program for implementing one or more functions according to the embodiments described above is supplied to a system or an apparatus via a network or a storage medium, and one or more processors in a computer of the system or the apparatus read out and execute the program. The present invention can also be implemented by a circuit (e.g., an application-specific integrated circuit (ASIC)) for implementing one or more functions according to the embodiments described above. The present invention is not limited by the above-described embodiments, and various alterations and modifications can be made without departing from the spirit and scope of the invention.

The disclosure of the embodiments includes an information processing apparatus, a control method therefor, and a program as described below.

### (Item 1)

A printing apparatus comprising:
a plurality of printhead portions for different ink colors, respectively, the printhead portions being configured to form an image with ink; and
a control unit configured to control a printhead portion for an ink color to be used during printing among the plurality of printhead portions to be located at a first position as a print position, and to control a printhead portion for an ink color not to be used during printing among the plurality of printhead portions to be located at a second position different from the first position.

### (Item 2)

The printing apparatus according to Item 1, in which the control unit further controls the printhead portion located at the first position to be heated and controls the printhead portion located at the second position not to be heated.

### (Item 3)

The printing apparatus according to Item 1 or Item 2, in which a distance between the printhead portion located at the second position and a conveyance belt configured to convey a printing medium is greater than a distance between the printhead portion located at the first position and the conveyance belt.

### (Item 4)

The printing apparatus according to any one of Items 1 to 3, in which during power-off of the printing apparatus, the control unit controls the plurality of printhead portions to be located at a third position different from the first position and the second position.

### (Item 5)

The printing apparatus according to Item 4, in which a distance between the printhead portion located at the second position and a conveyance belt configured to convey a printing medium is less than a distance between the printhead portions located at the third position and the conveyance belt.

### (Item 6)

The printing apparatus according to any one of Items 1 to 5, in which the control unit identifies a color not to be used during printing based on a print job analysis result, and controls a printhead portion for an ink color to be used during printing of the identified color to be located at the second position.

### (Item 7)

The printing apparatus according to any one of Items 1 to 5, in which the control unit identifies a color not to be used during printing based on information about a color mode, and controls a printhead portion for an ink color to be used during printing of the identified color to be located at the second position.

### (Item 8)

A control method for a printing apparatus configured to form an image with ink, the printing apparatus including a plurality of printhead portions for different ink colors, respectively, the control method including:
controlling a printhead portion for an ink color to be used during printing among the plurality of printhead portions to be located at a first position as a print position; and
controlling a printhead portion for an ink color not to be used during printing among the plurality of printhead portions to be located at a second position different from the first position.

### (Item 9)

The control method for the printing apparatus according to Item 8, in which the control includes controlling the printhead portion located at the first position to be heated and controlling the printhead portion located at the second position not to be heated.

### (Item 10)

The control method for the printing apparatus according to Item 8 or Item 9, in which a distance between the printhead portion located at the second position and a conveyance belt configured to convey a printing medium is greater than a distance between the printhead portion located at the first position and the conveyance belt.

### (Item 11)

The control method for the printing apparatus according to any one of Items 8 to 10, in which during power-off of the printing apparatus, the plurality of printhead portions is controlled to be located at a third position different from the first position and the second position.

### (Item 12)

The control method for the printing apparatus according to Item 11, in which a distance between the printhead portion located at the second position and a conveyance belt configured to convey a printing medium is less than a distance between the printhead portions located at the third position and the conveyance belt.

### (Item 13)

The control method for the printing apparatus according to any one of Items 8 to 12, in which the control includes identifying a color not to be used during printing based on a print job analysis result, and controlling a printhead portion for an ink color to be used during printing of the identified color to be located at the second position.

### (Item 14)

The control method for the printing apparatus according to any one of Items 8 to 12, in which the control includes identifying a color not to be used during printing based on information about a color mode, and controlling a printhead portion for an ink color to be used during printing of the identified color to be located at the second position.

### (Item 15)

A program for causing a computer to function as each unit of the printing apparatus according to any one of Items 1 to 7.

The present invention is not limited to the above-described embodiments. Various modifications and alterations may be made without departing from the spirit and scope of the invention. Accordingly, the claims are attached to publicize the scope of the invention.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to embodiments, it is to be understood that the invention is not limited to the disclosed embodiments, but is defined by the scope of the following claims. Each of the embodiments of the invention described above can be implemented solely or as a combination of a plurality of the embodiments. Also, features from different embodiments can be combined where necessary or where the combination of elements or features from individual embodiments in a single embodiment is beneficial.

This application claims the benefit of Japanese Patent Application No. 2023-077009, filed May 9, 2023, which is hereby incorporated by reference herein in its entirety.

What is claimed is:

1. A printing apparatus comprising:
a plurality of printhead portions for different ink colors, respectively, the printhead portions being configured to form an image with ink; and
a control unit configured to control a printhead portion for an ink color to be used during printing among the plurality of printhead portions to be located at a first position as a print position, and to control a printhead portion for an ink color not to be used during printing among the plurality of printhead portions to be located at a second position different from the first position.

2. The printing apparatus according to claim 1, wherein the control unit is further configured to control the printhead portion located at the first position to be heated, and control the printhead portion located at the second position not to be heated.

3. The printing apparatus according to claim 1, wherein a distance between the printhead portion located at the second position and a conveyance belt configured to convey a printing medium is greater than a distance between the printhead portion located at the first position and the conveyance belt.

4. The printing apparatus according to claim 1, wherein during power-off of the printing apparatus, the control unit is further configured to control the plurality of printhead portions to be located at a third position different from the first position and the second position.

5. The printing apparatus according to claim 4, wherein a distance between the printhead portion located at the second position and a conveyance belt configured to convey a printing medium is less than a distance between the printhead portions located at the third position and the conveyance belt.

6. The printing apparatus according to claim 1, wherein the control unit is configured to identify a color not to be used during printing based on a print job analysis result, and control a printhead portion for an ink color to be used during printing of the identified color to be located at the second position.

7. The printing apparatus according to claim 1, wherein the control unit is configured to identify a color not to be used during printing based on information about a color mode, and control a printhead portion for an ink color to be used during printing of the identified color to be located at the second position.

8. A method for a printing apparatus suitable for forming an image with ink, the printing apparatus including a plurality of printhead portions for different ink colors, respectively, the method comprising:
controlling a printhead portion for an ink color to be used during printing among the plurality of printhead portions to be located at a first position as a print position; and
controlling a printhead portion for an ink color not to be used during printing among the plurality of printhead portions to be located at a second position different from the first position.

9. The method according to claim 8, the method comprising controlling the printhead portion located at the first position to be heated and controlling the printhead portion located at the second position not to be heated.

10. The method according to claim 8, wherein a distance between the printhead portion located at the second position and a conveyance belt configured to convey a printing medium is greater than a distance between the printhead portion located at the first position and the conveyance belt.

11. The method according to claim 8, wherein during power-off of the printing apparatus, the plurality of printhead portions is controlled to be located at a third position different from the first position and the second position.

12. The method according to claim 11, wherein a distance between the printhead portion located at the second position and a conveyance belt configured to convey a printing medium is less than a distance between the printhead portions located at the third position and the conveyance belt.

13. The method according to claim 8, the method comprising identifying a color not to be used during printing based on a print job analysis result and controlling a printhead portion for an ink color to be used during printing of the identified color to be located at the second position.

14. The method according to claim 8, the method comprising identifying a color not to be used during printing based on information about a color mode, and controlling a printhead portion for an ink color to be used during printing of the identified color to be located at the second position.

15. A non-transitory computer-readable storage medium that stores one or more programs including instructions which, when executed by one or more processors of a printing apparatus configured to form an image with ink and including a plurality of printhead portions for different ink colors, respectively, cause an information processing apparatus to perform a control method,
the control method comprising:
controlling a printhead portion for an ink color to be used during printing among the plurality of printhead portions to be located at a first position as a print position; and
controlling a printhead portion for an ink color not to be used during printing among the plurality of printhead portions to be located at a second position different from the first position.
